(19) United States
(12) Patent Application Publication
(10) Pub. No.: US 2003/0230030 A1
(43) Pub. Date: Dec. 18, 2003

(54) Stop device for sliding closures including an alarm means and optional interchangeable safety features

(76) Inventors: Cathy D. Santa Cruz, Reno, NV (US); Edward A. Carwin, Reno, NV (US)

Correspondence Address: Cathy D. Santa Cruz, 7630 Tholl Drive, Reno, NV, 89506, US

(21) Appl. No.: 10/170,295

(22) Filed: Jun. 12, 2002

(51) Int. Cl. E05F 1/00

(52) U.S. Cl. 49/449

(57) ABSTRACT

A stop device that is useable with substantially any closure having a sliding panel movable with respect to a frame. The device being novel as it is not only very functional as a stop device but it also includes interchangeable removably attached safety accessories, such as burglar alarm and/or a smoke detector or the like. Also, each of the safety accessories can be disguised within a housing for aesthetic purposes, such as each may look like a toy, a flower, a cartoon character, etc.

### FIELD OF THE INVENTION

This invention relates to stop devices used on sliding closures, such as windows, sliding glass doors, etc., and is used to prevent unauthorized opening thereof. However, the device more particularly relates to an adjustable decorative stop device that is most aesthetically pleasing. It includes a locking mechanism and various removable interchangeable accessory items of user choice. Also the device is very strong, and further includes a burglar alarm as well as additional safety features, such as a smoke detector and/or visual message display, etc.

### BACKGROUND OF THE INVENTION

It is well known in the field that sliding closures such as windows, glass doors, etc., are used to not only prevent unauthorized entry into an otherwise enclosed room, but are most often used to provide ventilation and vary room temperature as well. Therefore, many times the user will only slightly open the window or door so as to allow air to circulate. Unfortunately, this provides easy entry for burglars or other criminals, thus this can be very dangerous.

Therefore, within the prior art many attempts have been taught to overcome the above noted problem. However, each has inherent drawbacks and disadvantages which the present invention not only recognizes, but also addresses and resolves in a manner heretofore not taught.

The most pertinent related prior art is taught within our issued U.S. Pat. Nos. 6,167,655 and 6,282,841, both of which are entitled “STOP DEVICE FOR SLIDING CLOSURES”. Wherein the first reference teaches a stop device that is very pleasing to the eye, however, the applicants have since found that the device has certain inherent disadvantages which the present invention overcomes. Such as the device is not as strong as it appears and in use is not quite as efficient as anticipated. For example, the locking mechanism as taught therein can be easily broken and the adjustment means for varying the length is much to limited. Thus, numerous sizes must be manufactured for various sized closures and this is therefore not cost effective.

The second of the two references is an improved version of the first which includes novel locking means and is much stronger. Unfortunately, the applicants have found that both inventions are somewhat limited as a burglar can dislodge either device which defeats the entire purpose of their intended use. Therefore, within the present application we now incorporate the unique features of both but we further include a burglar alarm and other interchangeable safety features, which will be later described herein.

Another example of known prior art is U.S. Pat. No. 5,102,173 entitled “REENFORCER FOR DOORS AND WINDOWS”. Wherein they provide a telescopic device that is formed from multiple slidably engaged members. With each of the members being locked into a position of user choice by pins which protrude from holes when adjusted into place. This device is somewhat functional for its intended use but it is not aesthetically pleasing, it is limited to locked positions according to placement of the pins, and includes parts which the present invention eliminates. Furthermore, the applicants contend this device would not be nearly strong enough to prevent opening of the closure. Due to the telescopic design each of the members are hollow, thus greatly reducing strength. Also, the only locking mechanism is the pins that can easily break when force is applied to the device. In addition, the device can be dislodged which again defeats its entire purpose and function.

Yet another prior art reference is U.S. Pat. No. 4,135,376, which teaches a “patio door security bar with lock” wherein they provide an elongated bar which is installed within the window framework with multiple screws and sliding bolts, etc. This device is again functional for its intended use but is much too complicated, most unsightly when installed, and includes many parts, etc.

Further pertinent prior art references include U.S. Pat. Nos. 4,429,911, 4,059,141, and 4,593,492, each of which attempt to provide a means to lock or secure a closure member in a fixed position. However, each reference is extremely complicated, they are much too costly and difficult to install, and none include the unique and novel features of the present invention as will be seen within the following specification.

### SUMMARY OF THE INVENTION

In accordance with the present invention we provide a stop device for sliding closures which inhibits opening of the sliding closure. It is a deterrent for unauthorized entry there through and further includes a burglar alarm of engineering choice.

It is accordingly a principle object of the present invention to provide a stop device comprising of first and second elongated members having a side-by-side relationship, with each being slidably contained within a housing and slidably adjustably engaged within a locking mechanism.

Also another object of the present invention is to provide a stop device wherein the above noted locking mechanism has manually finger-actuated levers or the like.

A further object of the present invention is to provide a stop device which is of a shape and size to be easily inserted within or removed from either a sliding glass door frame or window frame, etc., substantially irrespective of size.

It is another object of the present invention to provide a stop device which includes means to be adjustably variable in length which allows the user to partially open the closure at a position of choice, for ventilation purposes or the like.

Yet another object of the present invention is to provide a stop device which will not mar or damage the sliding closure in any way, as no installation tools are required, and no screws, bolts, etc., are used to secure the stop device into position.

A further object of the present invention is to provide a stop device which is of simple construction, and which can be made from substantially any desirable material of engineering choice, such as steel, plastic, etc.

Still a further object of the present invention is to provide a stop device which is lightweight and can be easily carried by an adult or a child.

Also, another very important object of the present invention to provide a stop device which is aesthetically pleasing and can be seen from either side of the closure.

A further object of the present invention is to provide a stop device which includes interchangeable decorative accessory attachments, such as a crystal ball, a comical figure, or even a holiday related attachment like a Christmas tree, etc. such as taught within our previously noted patents. However, we now also provide additional accessory items which are not only attractive but also function as safety features, such as a burglar alarm and/or a smoke detector, or the like.

A most important object of the present invention is to provide interchangeable safety features which can be interconnected to the stop device in numerous ways. This allows the consumer to pick and choose which safety features they personally prefer. For example, the consumer may buy only the stop device without any additional accessories and at later date they can purchase any accessories of their choice. Such as they may purchase only a burglar alarm or they may purchase a smoke detector, and/or a combination of both, etc.

Still another object of the present invention is to provide a stop device which may be coated with a fluorescent material, or each accessory item may be fluorescent so as to glow in the dark.

Also another object of the present invention is to provide a stop device which is universal and can be installed within typical sliding glass doors, windows which are horizontally aligned, or windows which are vertically aligned, respectively.

Still a further object of the present invention is to provide a stop device which requires minimal bending over to install, as the stop device includes an upwardly extending central support member which easily functions as a handle.

Yet another object of the present invention is to provide a stop device and a unique method of use.

Still a further object of the present invention is to provide a stop device which includes a burglar alarm so as to deter burglars from trying to dislodge the device. Also, depending on consumer choice, the device may further include a smoke detector and/or a message display. Whereby when the burglar alarm or smoke detector is activated, the device may display a message for help, or fire, or the like.

A further object of the present invention is to provide a stop device wherein the above noted alarm and other safety features can be incorporated within the actual removable accessories, within the locking mechanism, or within the central upright support member, depending on consumer and engineering choice.

Also, another object of the present invention is to provide a stop device that is much more stable and rests in an upright position, unlike the prior art which tends to tilt to one side or the other. This further allows the device to be much more versatile as it can be used with closures having different width and size configurations. This further provides a more stable device which functions well with the burglar alarm.

Other objects and advantages will be seen when taken into consideration with the following specification and drawings.

### BRIEF DESCRIPTION OF THE DRAWINGS

FIG. 1 is substantially a frontal view showing one embodiment of the present invention wherein the stop device includes a removably attached burglar alarm accessory.

FIG. 2 is substantially an enlarged frontal view of the burglar alarm of FIG. 1.

FIG. 3 is substantially a block diagram for the internal electrical components for the burglar alarm of FIG. 1.

FIG. 4 is substantially a frontal view showing one embodiment of the present invention wherein the stop device includes a removably attached smoke detector.

FIG. 5 is substantially a partial sectional view of the smoke detector taken along line 5-5 of FIG. 4.

FIG. 6 is substantially a frontal view of the stop device having a burglar alarm and a smoke detector in combination.

FIGS. 7A-C substantially depict frontal views of the stop device having various combinations such as a burglar alarm, a smoke detector and message display in combination.

FIG. 8 is substantially a partial end view of the stop device showing one embodiment for the preferred shape of the casing for the stop device.

FIG. 9 is substantially a partial end view of the stop device showing a second embodiment for the preferred shape of the casing for the stop device.

FIG. 10 is substantially a partial end view of the stop device showing a third embodiment for the preferred shape of the casing for the stop device.

FIG. 11 is substantially a partial end view of the stop device showing a fourth embodiment for the preferred shape of the casing for the stop device.

### DETAILED DESCRIPTION OF THE DRAWINGS

Referring now in detail to the drawings wherein like characters refer to like elements throughout the various views.

As shown in FIGS. 1, 4, 6 & 7, (10) represents an overview of the present invention which is substantially a new and unique stop device having interchangeable removably attached safety accessories in combination for a sliding closure. It is to be understood that substantially any sliding closure having a sliding panel movable with respect to a frame is suitable for use with the present invention, such as windows, sliding glass doors, etc., and the sliding closure may be either vertically or horizontally aligned, respectively.

The lock device (10) as depicted in FIGS. 1, 4, 6 & 7, includes a first elongated extension member (12), a second elongated extension member (14), a locking mechanism (16) and at least one interchangeable removably attached safety accessory, such as a burglar alarm (18). Locking mechanism (16) includes locked position and an unlocked position for adjustably locking and unlocking each elongated extension member (12 & 14) into a fixed position of choice. It is to be understood the locking mechanism can be any suitable locking mechanism of engineering choice. However, the locking mechanism as taught within our previous U.S. Pat. No. 6,282,841 is most functional and is to be incorporated herein, thus for details of the locking mechanism please refer to the noted patent. The only restriction for the current locking mechanism (16) is that it provides a housing (20) having attachment means for removably attaching one of the safety accessories onto the housing (20). It is to be understood any suitable attachment means of engineering choice may be implemented, such as a frictionally engaged protrusion, nuts, bolts, or the like. Therefore the following description for the attachment means is only exemplary and the present invention is not to be limited thereto.

Referring now to FIGS. 1, 2, and 3 wherein we show a first embodiment for one of the safety accessories, namely a burglar alarm (18) substantially comprising, a container (22) having a top end, a bottom end, and an internal compartment (24). With the internal compartment (24) being used for containment of appropriate electrical components pertaining to the burglar alarm (18). It is to be understood any suitable burglar alarm of engineering choice may be used, thus the present description for the present burglar alarm is only exemplary. Referring now to FIG. 3, wherein we show a block diagram for the electrical components including a power supply (26), a warning device (28), an on/off switch (30), a tilt sensor (32), and circuit board (34) for electrically interconnecting and operating the noted electrical components. It is to be noted the electrical components can be arranged in any manner according to engineering choice within internal compartment (24), thus the actual arrangement is not described nor shown within the present drawings for clarity purposes.

Referring now to the previously noted attachment means for removably attaching the safety accessory, namely burglar alarm (18) onto housing (20). Wherein the attachment means includes housing (20) having a threaded bore (36) therein, and the bottom end of container (22) having a threaded extension member (38) which is of a shape and size to be threadably engaged within threaded bore (36). Whereby, threaded extension member (38) can be easily threadably engaged within threaded bore (36) and burglar alarm (18) is removably yet securely attached onto housing (20).

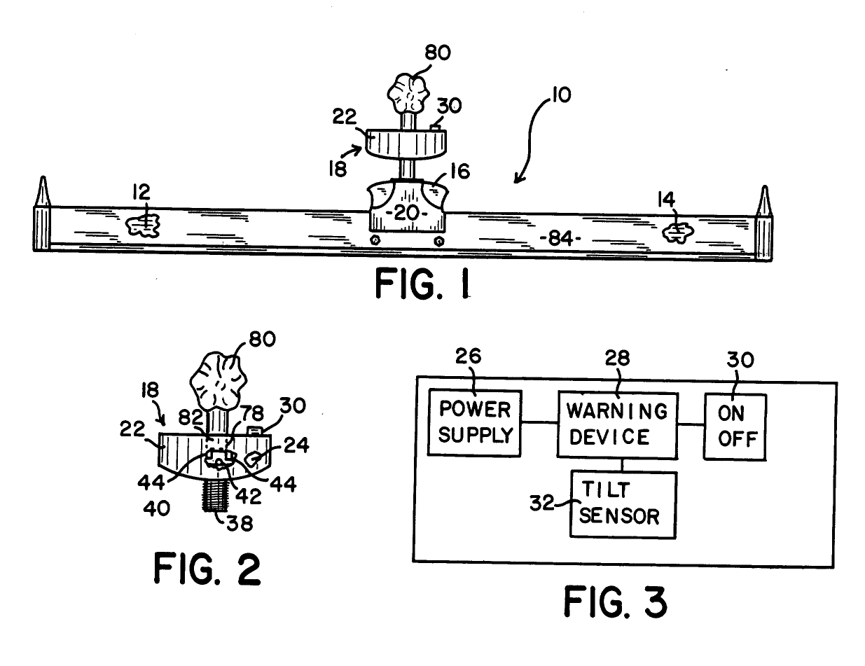

As can be seen in FIG. 2, the container (22) for burglar alarm (18) substantially includes a bowl shaped internal structure (40) respectively, which contains therein tilt sensor (32) having as a movable conductive member such as mercury (42) or the like, a series of electrodes (44) and the previously noted electrical components that are all arranged in series. It is to be understood that there are many different types of burglar alarms and such technology has been taught and well known within the art. Therefore we need not give specific details pertaining to function and actual connection of the noted electrical components, as this can be easily understood by anyone who is skilled in the art.

It can now be seen that when the burglar alarm (18) is installed onto stop device (10) and the on/off switch (30) is in the “on” position, the burglar alarm (18) is fully functional, and when stop device (10) is tampered with or slightly tilted, such as by an intruder, the warning device (28) is automatically activated.

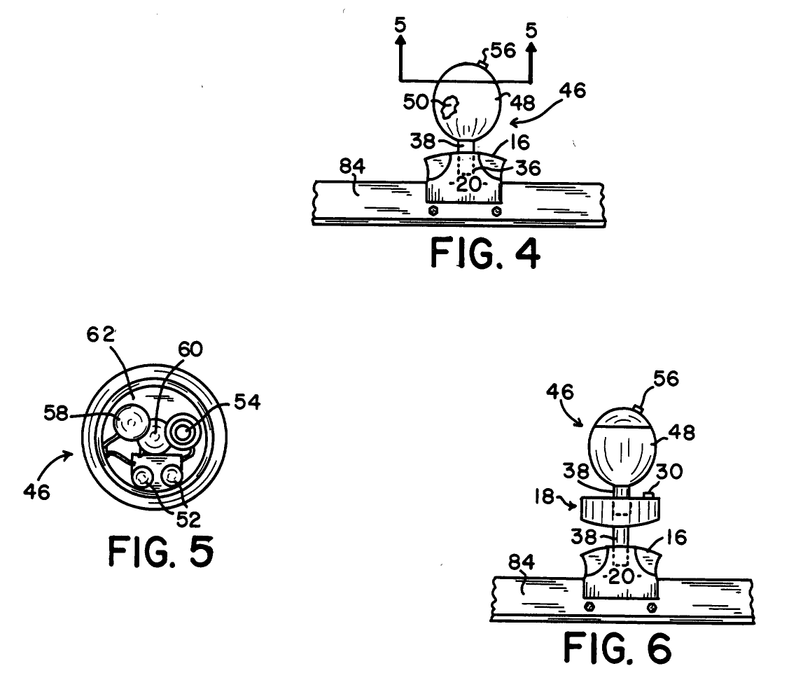

Referring now to FIGS. 4, 5 & 6, wherein we show a second embodiment for one of the safety accessories, namely a smoke detector (46) substantially comprising, a container (48) having a top end, a bottom end, and an internal compartment (50). With the internal compartment (50) being used for containment of appropriate electrical components pertaining to smoke detector (46). It is to be understood any suitable type of smoke detector of engineering choice may be used, thus the present description for the present smoke detector is only exemplary. Referring now to FIG. 5, which is substantially a cut-a-way plan view taken at 5-5 of FIG. 4. Wherein we show one arrangement for the noted electrical components pertaining to the smoke detector (46) including a power supply (52), a warning device (54), an on/off switch (56), a smoke detector module having a smoke responsive transducer (58), a signal light (60) and circuit board (62) for electrically interconnecting and operating the noted electrical components. It is to be noted the electrical components can be arranged in any manner according to engineering choice within internal compartment (50), thus the actual arrangement is not to be limited to the arrangement as taught herein.

As previously noted, each of the safety accessories may be interchanged according to the needs of the consumer. For example, the safety accessories can be interconnected and interchanged onto the stop device (10) in various combinations, such as the burglar alarm (18) or the smoke detector (46) can be installed individually, or in combination with an aesthetic decorative accessory, or a message display as hereafter described.

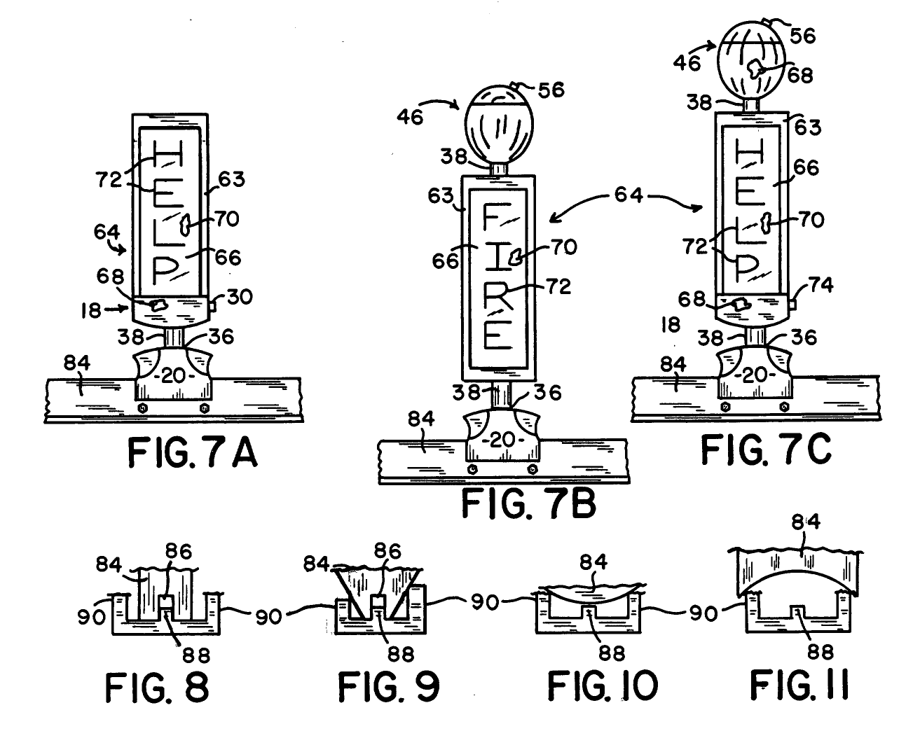

Referring now to FIG. 7-A, which substantially depicts one possible embodiment for combining the noted safety accessories. For example, burglar alarm (18) may be combined with a message display (64) in combination comprising a central upright support container (63) having a top end, a bottom end, a transparent message display window (66), a first internal compartment (68), and a second internal compartment (70).

The above noted first internal compartment (68) being used for containment of the noted electrical components pertaining to burglar alarm (18) as previously described, and the second internal compartment (70) being used for containment of electrical components pertaining to the message display (64). It is to be understood any suitable message display means of engineering choice may be used, thus the following description is only exemplary of one possible message display means.

The electrical components pertaining to the message display (64) including an array of light emitting diodes (72) which are electrically interconnected in series with the noted electrical components pertaining to burglar alarm (18). Furthermore, the light emitting diodes (72) are mounted within second compartment (70) and are visible through transparent message display window (66) and are arranged in series to display a message which when viewed spells “help”, or the like. It can now be seen when the on/off switch (74) pertaining to burglar alarm (18) is in the on position, burglar alarm (18) is fully functional, and when stop device (10) is tampered with or slightly tilted, the warning device (28) and message display (64) are simultaneously automatically activated.

Within FIG. 7-B we depict a different combination for the noted safety accessories. For example, smoke detector (46) may be combined with a message display (64) in combination comprising a central upright support container (63) having a top end, a bottom end, a transparent message display window (66), a first internal compartment (68), and a second internal compartment (70).

The above noted first internal compartment (68) being used for containment of the noted electrical components pertaining to smoke detector (46) as previously described, and the second internal compartment (70) being used for containment of electrical components pertaining to the message display (64), and further the noted array of light emitting diodes (72) are electrically interconnected in series with the noted electrical components pertaining to smoke detector (46). It is to be understood any suitable message display means of engineering choice may be used, such as previously described herein. However, the light emitting diodes (72) may be arranged differently so as to display a different message of engineering choice. Such as the display message which when viewed may spell “fire”, or the like.

It can now be seen when the on/off switch (56) pertaining to smoke detector (46) is in the on position, smoke detector (46) is fully functional, and when smoke detector (46) detects smoke, the warning device (54) and message display are simultaneously automatically activated.

Within FIG. 7-c we depict yet another different combination for the noted safety accessories. For example, burglar alarm (18), smoke detector (46) and message display (64) may be easily combined wherein the combination comprising a central upright support container (63) having a top end, a bottom end, a transparent message display window (66), a first internal compartment (68), a second internal compartment (70) and a third internal compartment (76).

The above noted first internal compartment (68) being used for containment of the noted electrical components pertaining to burglar alarm (18) as previously described, the second internal compartment (70) being used for containment of electrical components pertaining to the message display (64) as previously described, and the third internal compartment being used for containment of electrical components pertaining to smoke detector (46), as previously described. In this embodiment it is to be understood that the noted array of light emitting diodes (72) are electrically interconnected in series with the noted electrical components pertaining to the burglar alarm (18) and smoke detector (46).

It can now be seen when the first on/off switch (30) pertaining to the burglar alarm (18) is in the on position, the burglar alarm is fully functional, and when the stop device (10) is tampered with or slightly tilted, the first warning device (28) and message display (64) are automatically activated. It can further be seen that when the second on/off switch (56) pertaining to smoke detector (46) is in the on position, smoke detector (46) is fully functional, and when smoke detector (46) detects smoke, the second warning device (54) and message display (64) are simultaneously automatically activated.

As previously noted, each of the safety accessories may be used individually or in combination, as the housing (20) includes attachment means for removably attaching any of the safety accessories onto housing (20). For example, as depicted in FIGS. 1, 2, 4, 6 & 7 housing (20) includes a threaded bore (36) therein, and the bottom end of each container (22,48 & 63) include a threaded extension member (38) which are of a shape and size to be threadably engaged within threaded bore (36).

To allow for further combinations, burglar alarm (18) may include attachment means for removably attaching an additional safety accessory and/or an aesthetically pleasing accessory onto burglar alarm (18). It is to be understood that if so desired, smoke detector (46) may further provide the noted attachment means for an additional safety accessory. However, it is most feasible that the burglar alarm (18) be mounted beneath the smoke detector (46) rather than on top, due to the fact that smoke rises. Also, due to this fact, it may be desirable to include optional containers (63) each of which being of different heights, depending on engineering choice and consumer needs.

Referring back to the attachment means for removably attaching an additional safety accessory onto burglar alarm (18). Again any suitable attachment means may be incorporated. For example, the top end of container (22) may include a threaded bore (78) therein, and the additional safety feature, (such as smoke detector (46) or an ornamental accessory (80), “the later only shown in FIGS. 1 & 2”,) having a threaded extension member (82) which is of a shape and size to be threadably engaged within threaded bore (78).

Referring now to FIGS. 8-11 wherein we substantially partially show a plan view of the stop device having different configurations, so as to be adaptable to different types of sliding closures. For example, in FIG. 8, we show that each of the elongated extension members (12 & 14) are slidably contained within a casing (84), which includes a top section and a bottom section. With the bottom section forming an elongated slot (86) between two opposing edges for slidably receiving and mating with a typical upraised ridge (88) such as normally associated with most sliding closures. Each of the opposing edges being shaped to provide optimal performance. For example in FIG. 8, the first embodiment teaches the opposing edges being substantially squared, or flat, and this tends to be functional and adaptable to some closures but not all. In some closures this design tends to not allow the stop device to stand in an upright position. Therefore, in some instances the embodiment of FIG. 9, is more functional wherein the opposing edges are substantially angled inwardly toward elongated slot (86). Also, this design tends to fit most closures and the stop device sits in a more stable upright position. Still further this design is more functional when the stop device includes the burglar alarm (18) as this allows the tilt sensor to function properly. Yet another embodiment is depicted in FIG. 10 wherein the opposing edges are substantially rounded upward. This is also functional especially when the upraised ridge (88) is not of standard height, as the stop device tends to rest on the outer ledges (90) of the sliding closure rather than having a mating relationship between elongated slot (86) and upraised ridge (88). This is also true pertaining the embodiment depicted in FIG. 11, wherein the opposing edges are substantially rounded in a downward direction, which is also very functional.

It will now be seen we have herein provided a new and unique stop device for sliding closures which does not require any tools, screws, bolts, etc., for installation of the present invention and will not mar or damage the closure in any manner.

It will further be seen we have herein provided a stop device which is adjustable in length, is aesthetically pleasing and includes interchangeable removably attached safety accessories. With the accessories being removably interchangeable so as to allow the consumer to mix and match according to their liking.

It is to be understood that throughout the present application wherein each noted warning device, (28 & 54) is not to be limited to any specific type, although the applicants prefer an audible alarm. For example, the alarm can be a whistle, a buzzer, a recorded voice, a bell, etc. However, other types of alarms may be incorporated as well, such as a foul odor, a strobe light, or flashing lights, etc. It is to be noted the foul odor alarm may be very functional for consumers who may be deaf and/or blind.

It is to be further understood that the noted signal light 60, can be incorporated in a manner of ways as well. For example, the light may be used strictly to notify a user that the light is functional and the safety accessory is in operating order, or the light may be pulsed for added affect, etc. Or if preferred, the light may only illuminate when the accessory is in the warning mode.

Yet another option for the present invention may be to include a communication means for relaying a message from either the burglar alarm or smoke detector to a remote location, such as to a burglar alarm company or the like. Also, the noted safety accessories may further include other types of sensors, such as carbon monoxide, propane, radiation, etc.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described our invention, what we claim as new and desire to secure by Letters Patent is:

1. A stop device having interchangeable removably attached safety accessories in combination, for use with a closure having a sliding panel movable with respect to a frame, comprising: a first elongated extension member; a second elongated extension member; a locking mechanism; and at least one safety accessory; said locking mechanism having a locked position and an unlocked position for adjustably locking and unlocking each said elongated extension member into a fixed position of choice, said locking mechanism providing a housing, and said housing having attachment means for removably attaching said safety accessory onto said housing.

2. The stop device of claim 1 wherein said safety accessory is in the form of a burglar alarm.

3. The stop device of claim 2 wherein said burglar alarm comprising: a container having a top end, a bottom end, and an internal compartment, said internal compartment being used for containment of electrical components, said electrical components including a power supply, an on/off switch, a tilt sensor, a warning device, and a circuit board for electrically interconnecting and operating said electrical components, said attachment means for removably attaching said safety accessory onto said housing includes said housing having a threaded bore therein, and said bottom end of said container having a threaded extension member which is of a shape and size to be threadably engaged within said threaded bore,
whereby:
when said on/off switch is in the on position said burglar alarm is fully functional, and when said stop device is tampered with or slightly tilted, said warning device is automatically activated.

4. The stop device of claim 1 wherein said safety accessory is in the form of a smoke detector.

5. The stop device of claim 4 wherein said smoke detector comprising: a container having a top end, a bottom end, and an internal compartment, said internal compartment being used for containment of electrical components, said electrical components including a power supply, an on/off switch, a smoke responsive transducer, a signal light, a warning device, and a circuit board for electrically interconnecting and operating said electrical components, said attachment means for removably attaching said smoke detector onto said housing includes said housing having a threaded bore therein, and said bottom end of said container having a threaded extension member which is of a shape and size to be threadably engaged within said threaded bore,
whereby:
when said on/off switch is in the on position said smoke detector is fully functional, and when said smoke detector detects smoke, said warning device is automatically activated.

6. The stop device of claim 3 wherein said warning device is an audible alarm.

7. The stop device of claim 5 wherein said warning device is an audible alarm.

8. The stop device of claim 3 wherein said top end of said container further includes attachment means for removably attaching an additional safety accessory onto said burglar alarm, said attachment means including said top end of said container having a threaded bore therein, and said additional safety accessory having a threaded extension member which is of a shape and size to be threadably engaged within said threaded bore.

9. The stop device of claim 8 wherein said additional safety accessory is in the form of a smoke detector comprising, a container having a top end, a bottom end, and an internal compartment, said internal compartment being used for containment of electrical components, said electrical components including a power supply, an on/off switch, a smoke responsive transducer, a signal light, a warning device, and a circuit board for electrically interconnecting and operating said electrical components.

10. The stop device of claim 1 wherein said safety accessory is in the form of a burglar alarm and a message display in combination comprising: a central upright support container having a top end, a bottom end, a transparent message display window, a first internal compartment, and a second internal compartment, said first internal compartment being used for containment of electrical components pertaining to said burglar alarm including a power supply, an on/off switch, a tilt sensor, a warning device, and a circuit board for electrically interconnecting and operating said electrical components pertaining to said burglar alarm, said second internal compartment being used for containment of electrical components pertaining to said message display including an array of light emitting diodes which are electrically interconnected in series with said electrical components pertaining to said burglar alarm, said light emitting diodes being mounted within said second internal compartment and are visible through said transparent message display window, said attachment means for removably attaching said safety accessory onto said housing includes said housing having a threaded bore therein, and said bottom end of said central upright support container having a threaded extension member which is of a shape and size to be threadably engaged within said threaded bore,
whereby:
when said on/off switch is in the on position said burglar alarm is fully functional, and when said stop device is tampered with or slightly tilted, said warning device and said message display are simultaneously activated.

11. The stop device of claim 1 wherein said safety accessory is in the form of a smoke detector and a message display in combination comprising: a central upright support container having a top end, a bottom end, a transparent message display window, a first internal compartment, and a second internal compartment, said first internal compartment being used for containment of electrical components pertaining to said smoke detector including a power supply, an on/off switch, a smoke responsive transducer, a signal light, a warning device, and a circuit board for electrically interconnecting and operating said electrical components pertaining to said smoke detector, said second internal compartment being used for containment of electrical components pertaining to said message display including an array of light emitting diodes which are electrically interconnected in series with said electrical components pertaining to said smoke detector, said light emitting diodes being mounted within said second internal compartment and are visible through said transparent message display window, said attachment means for removably attaching said safety accessory onto said housing includes said housing having a threaded bore therein, and said bottom end of said central upright support container having a threaded extension member which is of a shape and size to be threadably engaged within said threaded bore,
whereby:
when said on/off switch is in the on position said smoke detector is fully functional, and when smoke detector detects smoke, said warning device and said message display are automatically activated.

12. The stop device of claim 1 wherein said interchangeable removably attached safety accessories include a burglar alarm and a smoke detector in combination.

13. The stop device of claim 1 wherein said interchangeable removably attached safety accessories include a burglar alarm, a smoke detector, and a message display in combination.

14. The stop device of claim 13 wherein said burglar alarm, said smoke detector, and said message display in combination comprising: a central upright support container having a top end, a bottom end, a transparent message display window, a first internal compartment, a second internal compartment, and a third internal compartment, said first internal compartment being used for containment of electrical components pertaining to said burglar alarm including a power supply, an on/off switch, a tilt sensor, a warning device, and a circuit board for electrically interconnecting and operating said electrical components pertaining to said burglar alarm, said second internal compartment being used for containment of electrical components pertaining to said message display including an array of light emitting diodes which are electrically interconnected in series with said electrical components pertaining to said burglar alarm, said light emitting diodes being mounted within said second internal compartment and are visible through said transparent message display window, said third internal compartment being used for containment of electrical components pertaining to said smoke detector including, a power supply, an on/off switch, a smoke responsive transducer, a signal light, a warning device, and a circuit board for electrically interconnecting and operating said electrical components pertaining to said smoke detector, said array of light emitting diodes being electrically interconnected in series with said electrical components pertaining to said smoke alarm, and said attachment means for removably attaching said safety accessory onto said housing includes said housing having a threaded bore therein, and said bottom end of said central upright support container having a threaded extension member which is of a shape and size to be threadably engaged within said threaded bore,
whereby:
when first said on/off switch is in the on position said burglar alarm is fully functional, and when said stop device is tampered with or slightly tilted, first said warning device and said message display are automatically activated and when second said on/off switch is in the on position said smoke detector is fully functional, and when said smoke detector detects smoke, said second warning device and said message display are automatically activated.

15. The stop device of claim 14 wherein said light emitting diodes are arranged in series so as to display a message which when viewed spells help when said burglar alarm is activated.

16. The stop device of claim 14 wherein said light emitting diodes are arranged in series so as to display a message which when viewed spells fire when said fire alarm is activated.

17. The stop device of claim 14 further includes each said elongated extension member being slidably contained within a casing, said casing having a top section and a bottom section, said bottom section forming an elongated slot between two opposing edges, and said two opposing edges each being angled inwardly toward said elongated slot.

18. The stop device of claim 17 further includes each said elongated extension member being slidably contained within a casing, said casing having a top section and a bottom section, said bottom section forming an elongated slot between two opposing edges, and said two opposing edges being rounded.
